(19) United States
(12) Patent Application Publication
(10) Pub. No.: US 2024/0416567 A1
(43) Pub. Date: Dec. 19, 2024

(54) PRODUCTION MANAGEMENT DEVICE AND PRODUCTION DEVICE

(71) Applicant: SUMITOMO HEAVY INDUSTRIES, LTD., Tokyo (JP)

(72) Inventor: Tomosuke KADOONO, Chiba (JP)

(21) Appl. No.: 18/670,026

(22) Filed: May 21, 2024

(30) Foreign Application Priority Data
Jun. 16, 2023 (JP) 2023-099183

(51) Int. Cl. B29C 45/17; B29C 45/76; B29C 45/77; B29C 45/78; B29C 45/80; G05B 13/02

(52) U.S. Cl. CPC B29C 45/1774; B29C 45/768; G05B 13/021; B29C 2045/7606; B29C 45/7653; B29C 45/77; B29C 45/78; B29C 45/80; B29C 2945/76013; B29C 2945/7604; B29C 2945/76083; B29C 2945/7612; B29C 2945/76187; B29C 2945/7619; B29C 2945/76227

(57) ABSTRACT

A production management device includes circuitry configured to display, on a display unit, detection results detected by a detection unit in a process of producing a product upon a plurality of products being produced by a production device; and display, upon receiving selection of a detection result or information for identifying the product, a detection result of a first product together with a detection result of a second product and a detection result of a third product on the display unit, the first product being identified by the detection result or the information for identifying the product, the second product being produced by the production device immediately before the first product, and the third product being produced by the production device immediately after the first product.

### CROSS-REFERENCE TO RELATED APPLICATIONS

This application is based upon and claims priority to Japanese Patent Application No. 2023-099183, filed on Jun. 16, 2023, the entire contents of which are incorporated herein by reference.

### BACKGROUND

### 1. Technical Field

The present disclosure relates to a production management device, and a production device.

### 2. Description of Related Art

In recent years, production devices are configured to display detection results detected by various sensors while products are being produced, in order to make users identify a situation during production. For example, a related art technique is disclosed for displaying actual values for each shot by an injection molding machine as logging data indicating a previous history as well as displaying statistical data based on the logging data.

### SUMMARY

According to one embodiment of the present invention, a production management device includes
circuitry configured to
   display, on a display unit, detection results detected by a detection unit in a process of producing a product upon a plurality of products being produced by a production device; and
   display, upon receiving selection of a detection result or information for identifying the product, a detection result of a first product together with a detection result of a second product and a detection result of a third product on the display unit, the first product being identified by the detection result or the information for identifying the product, the second product being produced by the production device immediately before the first product, and the third product being produced by the production device immediately after the first product.

### BRIEF DESCRIPTION OF THE DRAWINGS

FIG. 1 is a view illustrating a state of an injection molding machine according to an embodiment at the time of completion of mold opening.

FIG. 2 is a view illustrating a state of the injection molding machine according to the embodiment at the time of mold clamping.

FIG. 3 is a functional block diagram illustrating components of a control device for the injection molding machine according to an embodiment.

FIG. 4 is a diagram illustrating a log information screen output by a display control unit according to the embodiment.

FIG. 5 is a diagram illustrating an example of a change in a screen when selection of a maximum value in a setting field of a statistics list on a log information screen according to the embodiment is received.

FIG. 6 is a diagram illustrating a log information screen output by the display control unit according to a modification of the embodiment.

FIG. 7 is a diagram illustrating an example of a change in a screen when an operation of sorting by CH5 is received in a result list of the log information screen according to another embodiment.

FIG. 8 is a diagram illustrating an example of a change in a screen when an operation for filtering by CH5 is received in the result list of the log information screen according to a modification of another embodiment.

FIG. 9 is a diagram illustrating an example of a log information screen output by a display control unit according to a still another embodiment.

FIG. 10 is a diagram illustrating a log information screen output by a display control unit according to a modification of the still another embodiment.

FIG. 11 is a block diagram illustrating a configuration of an injection molding machine and a management device according to a further another embodiment.

### DETAILED DESCRIPTION

In the related art technique, even when the statistical data or the like is displayed, it appears difficult for an operator to identify under what circumstances a product is produced for which a value (e.g., maximum or minimum value) is detected in the statistical data.

Accordingly, at least one embodiment of the present disclosure is to provide a technique for facilitating identification of a situation in the production of a product by displaying a detection result relating to a product specified on the basis of a received operation as well as displaying detection results relating to products produced before and after the product.

According to the embodiments, a technique is provided for facilitating identification of a situation at the time of production of a product by displaying a detection result relating to a product specified based on a received operation, as well as displaying detection results relating to products produced before and after the specified product.

Hereinafter, embodiments of the present disclosure will be described with reference to the accompanying drawings. The embodiments described below are not intended to limit the invention but are merely examples, and all features and combinations thereof described in the embodiments are not necessarily essential to the invention. In the drawings, the same or corresponding components are denoted by the same or corresponding reference numerals, and the description thereof may be omitted.

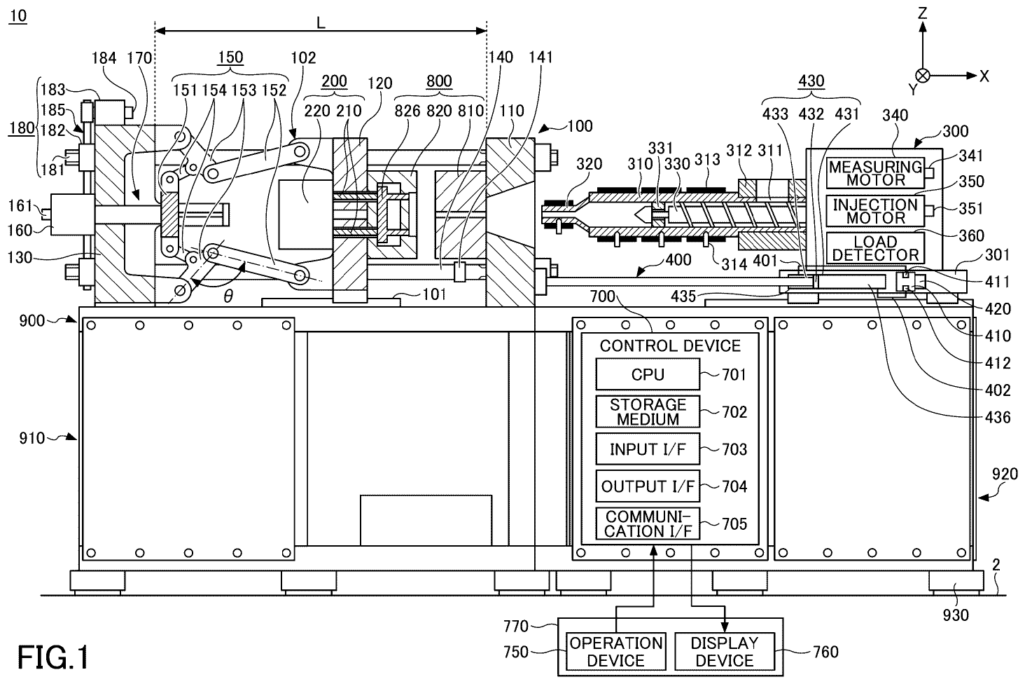

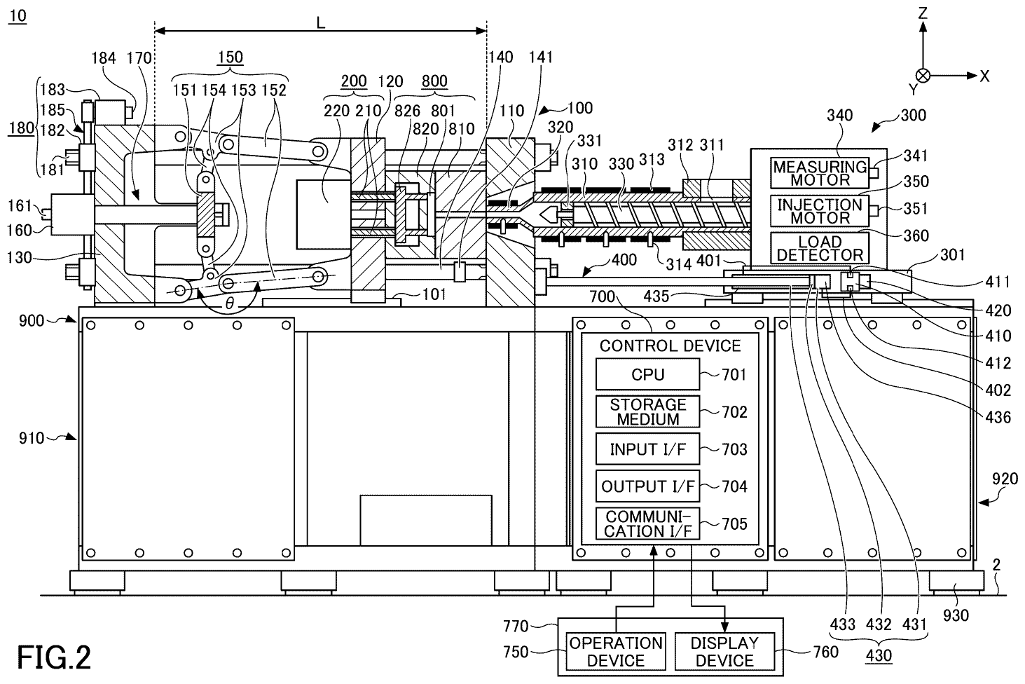

FIG. 1 is a view illustrating a state of an injection molding machine according to a embodiment at the time of completion of mold opening. FIG. 2 is a view illustrating a state of the injection molding machine according to the embodiment at the time of mold clamping. In the present specification, an X-axis direction, a Y-axis direction, and a Z-axis direction are directions perpendicular to each other. The X-axis direction and the Y-axis direction represent a horizontal direction, and the Z-axis direction represents a vertical direction. When a mold clamping device 100 is a horizontal type, the X-axis direction is a mold opening/closing direction, and the Y-axis direction is a width direction of an injection molding machine 10. The negative side in the Y-axis direction is called an operating side, and the positive side in the Y-axis direction is called a non-operating side.

As illustrated in FIGS. 1 and 2, the injection molding machine 10 includes the mold clamping device 100 that opens and closes a mold device 800, an ejector device 200 that ejects a molded article molded by the mold device 800, an injection device 300 that injects a molding material into the mold device 800, a moving device 400 that moves the injection device 300 back and forth with respect to the mold device 800, a control device 700 that controls each component of the injection molding machine 10, and a frame 900 that supports each component of the injection molding machine 10. The frame 900 includes a mold clamping device frame 910 that supports the mold clamping device 100 and an injection device frame 920 that supports the injection device 300. The mold clamping device frame 910 and the injection device frame 920 are each installed on the floor 2 via leveling adjusters 930. The control device 700 is disposed in the internal space of the injection device frame 920. Hereinafter, each component of the injection molding machine 10 will be described.

### (Mold Clamping Device)

In the description of the mold clamping device 100, a moving direction (e.g., an X-axis positive direction) of a movable platen 120 at the time of mold closing is referred to as a front side, and a moving direction (e.g., an X-axis negative direction) of the movable platen 120 at the time of mold opening is referred to as a rear side.

The mold clamping device 100 performs mold closing, pressurizing, mold clamping, depressurizing, and mold opening of the mold device 800. The mold device 800 includes a fixed mold 810 and a movable mold 820. The mold clamping device 100 is, for example, a horizontal type, and the mold opening/closing direction is a horizontal direction. The mold clamping device 100 includes a fixed platen 110 to which the fixed mold 810 is attached, a movable platen 120 to which the movable mold 820 is attached, and a moving mechanism 102 that moves the movable platen 120 in a mold opening/closing direction with respect to the fixed platen 110.

The fixed platen 110 is fixed to the mold clamping device frame 910. The fixed mold 810 is attached to a surface of the fixed platen 110 facing the movable platen 120. The movable platen 120 is disposed so as to be movable in the mold opening/closing direction with respect to the mold clamping device frame 910. A guide 101 for guiding the movable platen 120 is laid on the mold clamping device frame 910. The movable mold 820 is attached to a surface of the movable platen 120 facing the fixed platen 110.

The moving mechanism 102 moves the movable platen 120 back and forth with respect to the fixed platen 110 to perform mold closing, pressurizing, mold clamping, depressurizing, and mold opening of the mold device 800. The moving mechanism 102 includes a toggle support 130 disposed at a distance from the fixed platen 110, tie bar 140 connecting the fixed platen 110 and the toggle support 130, a toggle mechanism 150 moving the movable platen 120 in the mold opening/closing direction with respect to the toggle support 130, a mold clamping motor 160 operating the toggle mechanism 150, a motion conversion mechanism 170 converting a rotational motion of the mold clamping motor 160 into linear motion, and a mold thickness adjustment mechanism 180 adjusting the distance between the fixed platen 110 and the toggle support 130.

The toggle support 130 is disposed with a space from the fixed platen 110 and is placed on the mold clamping device frame 910 so as to be movable in the mold opening/closing direction. The toggle support 130 may be disposed so as to be movable along a guide laid on the mold clamping device frame 910. The guide of the toggle support 130 may be common to the guide 101 of the movable platen 120.

In the present embodiment, the fixed platen 110 is fixed to the mold clamping device frame 910, and the toggle support 130 is disposed so as to be movable in the mold opening/closing direction with respect to the mold clamping device frame 910, but the toggle support 130 may be fixed to the mold clamping device frame 910, and the fixed platen 110 may be disposed so as to be movable in the mold opening/closing direction with respect to the mold clamping device frame 910.

The tie bar 140 connects the fixed platen 110 and the toggle support 130 with an interval L in the mold opening/closing direction. A plurality of (e.g., four) tie bars 140 may be used. The plurality of tie bars 140 are disposed in parallel in the mold opening/closing direction and extend according to the mold clamping force. A tie bar strain detector 141 for detecting strain of the tie bar 140 may be provided on at least one tie bar 140. The tie bar strain detector 141 sends a signal indicating a detection result to the control device 700. The detection result of the tie bar strain detector 141 is used for detection of the mold clamping force and the like.

In the present embodiment, the tie bar strain detector 141 is used as a mold clamping force detector that detects the mold clamping force, but the configuration of the present embodiment of the present disclosure is not limited to this example. The mold clamping force detector is not limited to a strain gauge type, and may be a piezoelectric type, a capacitance type, a hydraulic type, an electromagnetic type, or the like, and the position to which the mold clamping force detector is attached is not limited to the tie bar 140.

The toggle mechanism 150 is disposed between the movable platen 120 and the toggle support 130, and moves the movable platen 120 in the mold opening/closing direction with respect to the toggle support 130. The toggle mechanism 150 includes a crosshead 151 that moves in the mold opening/closing direction, and a pair of link groups that contract and extend by the movement of the crosshead 151. The pair of link groups each include a first link 152 and a second link 153 which are connected to each other by a pin or the like so as to be extendable and contractible. The first link 152 is attached to the movable platen 120 by a pin or the like so as to be swingable. The second link 153 is swingably attached to the toggle support 130 by a pin or the like. The second link 153 is attached to the crosshead 151 via a third link 154. When the crosshead 151 is moved back and forth with respect to the toggle support 130, the first link 152 and the second link 153 are extended or contracted, and the movable platen 120 is moved back and forth with respect to the toggle support 130.

The configuration of the toggle mechanism 150 is not limited to the configuration illustrated in FIGS. 1 and 2. For example, in FIGS. 1 and 2, the number of nodes of each link group is five, but may be four, and one end of the third link 154 may be coupled to the node between the first link 152 and the second link 153.

The mold clamping motor 160 is attached to the toggle support 130 and operates the toggle mechanism 150. The mold clamping motor 160 moves the crosshead 151 back and forth with respect to the toggle support 130 to contract and extend the first link 152 and the second link 153, and moves the movable platen 120 back and forth with respect to the toggle support 130. The mold clamping motor 160 is directly connected to the motion conversion mechanism 170, but may be connected to the motion conversion mechanism 170 via a belt, a pulley, or the like.

The motion conversion mechanism 170 converts a rotational motion of the mold clamping motor 160 into a linear motion of the crosshead 151. The motion conversion mechanism 170 includes a screw shaft and a screw nut screwed to the screw shaft. Balls or rollers may be interposed between the screw shaft and the screw nut.

The mold clamping device 100 performs a mold closing process, a pressurizing process, a mold clamping process, a depressurizing process, a mold opening process, and the like under the control of the control device 700.

In the mold closing process, the mold clamping motor 160 is driven to advance the crosshead 151 to a mold closing completion position at a set moving speed, thereby advancing the movable platen 120 and causing the movable mold 820 to touch the fixed mold 810. The position and the moving speed of the crosshead 151 are detected by using, for example, a mold clamping motor encoder 161. The mold clamping motor encoder 161 detects the rotation of the mold clamping motor 160 and sends a signal indicating a detection result to the control device 700.

The crosshead position detector that detects the position of the crosshead 151 and the crosshead moving speed detector that detects the moving speed of the crosshead 151 are not limited to the mold clamping motor encoder 161, and a general detector may be used. Further, the movable platen position detector for detecting the position of the movable platen 120 and the movable platen moving speed detector for detecting the moving speed of the movable platen 120 are not limited to the mold clamping motor encoder 161, and a general detector may be used.

In the pressurizing process, the mold clamping force is generated by further driving the mold clamping motor 160 to further advance the crosshead 151 from the mold closing completion position to a mold clamping position.

In the mold clamping process, the mold clamping motor 160 is driven to maintain the position of the crosshead 151 at the mold clamping position. In the mold clamping process, the mold clamping force generated in the pressurizing process is maintained. In the mold clamping process, a cavity space 801 (see FIG. 2) is formed between the movable mold 820 and the fixed mold 810, and the injection device 300 fills the cavity space 801 with a liquid molding material. The filled molding material is solidified to obtain a molded article.

The number of cavity spaces 801 may be one or more. In the latter case, a plurality of molded articles are obtained simultaneously. An insert material may be disposed in a part of the cavity space 801, and a molding material may be filled in another part of the cavity space 801. A molded article is obtained by integrating the insert material and the molding material.

In the depressurizing process, the mold clamping motor 160 is driven to retract the crosshead 151 from the clamping position to the mold opening start position, thereby retracting the movable platen 120 and reducing the clamping force. The mold opening start position and the mold closing completion position may be the same position.

In the mold opening process, the mold clamping motor 160 is driven to retract the crosshead 151 from the mold opening start position to the mold opening completion position at the set moving speed, thereby retracting the movable platen 120 and separating the movable mold 820 from the fixed mold 810. Thereafter, the ejector device 200 ejects the molded article from the movable mold 820.

The setting conditions in the mold closing process, the pressurizing process, and the mold clamping process are collectively set as a series of setting conditions. For example, the moving speed and position (including a mold closing start position, a moving speed switching position, the mold closing completion position, and mold clamping position) of the crosshead 151 in the mold closing process and the pressurizing process, and the mold clamping force are collectively set as a series of setting conditions. The mold closing start position, the moving speed switching position, the mold closing completion position, and the mold clamping position are disposed in this order from the rear side to the front side, and represent a start point and an end point of a section in which the moving speed is set. A moving speed is set for each section. The number of moving speed switching positions may be one or more. The moving speed switching position may not be set. Only one of the mold clamping position and the mold clamping force may be set.

The setting conditions in the depressurizing process and the mold opening process are set in the same manner. For example, the moving speed and position (the mold opening start position, the moving speed switching position, and the mold opening completion position) of the crosshead 151 in the depressurizing process and the mold opening process are collectively set as a series of setting conditions. The mold opening start position, the moving speed switching position, and the mold opening completion position are disposed in this order from the front side to the rear side, and represent a start point and an end point of a section in which the moving speed is set. A moving speed is set for each section. The number of the moving speed switching positions may be one or more. The moving speed switching position may not be set. The mold opening start position and the mold closing completion position may be the same position. The mold opening completion position and the mold closing start position may be the same position.

Instead of the moving speed and the position of the crosshead 151, the moving speed and the position of the movable platen 120 may be set. Further, instead of the position of the crosshead (e.g., the mold clamping position) or the position of the movable platen, the mold clamping force may be set.

The toggle mechanism 150 amplifies the driving force of the mold clamping motor 160 and transmits the amplified driving force to the movable platen 120. The amplification factor is also called a toggle factor. The toggle magnification changes according to an angle θ formed by the first link 152 and the second link 153 (hereinafter, also referred to as a “link angle θ”). The link angle θ is obtained from the position of the crosshead 151. When the link angle θ is 180°, the toggle magnification is maximized. When the thickness of the mold device 800 changes due to the replacement of the mold device 800 or the temperature change of the mold device 800, the mold thickness is adjusted such that a predetermined mold clamping force is obtained at the time of mold clamping. In the mold thickness adjustment, for example, the interval L between the fixed platen 110 and the toggle support 130 is adjusted such that the link angle θ of the toggle mechanism 150 becomes a predetermined angle at the time of mold touch when the movable mold 820 touches the fixed mold 810.

The mold clamping device 100 includes the mold thickness adjustment mechanism 180. The mold thickness adjustment mechanism 180 adjusts the mold thickness by adjusting the interval L between the fixed platen 110 and the toggle support 130. The thickness adjustment is performed, for example, between the end of a molding cycle and the start of the next molding cycle. The mold thickness adjustment mechanism 180 includes, for example, a screw shaft 181 formed at the rear end portion of the tie bar 140, a screw nut 182 held by the toggle support 130 so as to be rotatable and not to be movable back and forth, and a mold thickness adjustment motor 183 that rotates the screw nut 182 screwed to the screw shaft 181.

The screw shaft 181 and the screw nut 182 are provided for each tie bar 140. The rotational driving force of the mold thickness adjustment motor 183 may be transmitted to the plurality of screw nuts 182 via the rotational driving force transmission unit 185. The plurality of screw nuts 182 can be rotated synchronously. Note that the plurality of screw nuts 182 can be individually rotated by changing a transmission path of the rotational driving force transmission unit 185.

The rotational driving force transmission unit 185 is configured by, for example, gears and the like. In this case, a driven gear is formed on the outer periphery of each screw nut 182, a driving gear is attached to the output shaft of the mold thickness adjustment motor 183, and an intermediate gear, which meshes with the plurality of driven gears and the driving gear, is rotatably held at the center of the toggle support 130. The rotational driving force transmission unit 185 may be configured by a belt, a pulley, or the like instead of the gear.

The operation of the mold thickness adjustment mechanism 180 is controlled by the control device 700. The control device 700 drives the mold thickness adjustment motor 183 to rotate the screw nuts 182. As a result, the position of the toggle support 130 with respect to the tie bar 140 is adjusted, and the interval L between the fixed platen 110 and the toggle support 130 is adjusted. A plurality of mold thickness adjustment mechanisms may be used in combination.

The interval L is detected by using the mold thickness adjustment motor encoder 184. The mold thickness adjustment motor encoder 184 detects the rotation amount and the rotation direction of the mold thickness adjustment motor 183, and sends a signal indicating a detection result to the control device 700. The detection result of the mold thickness adjustment motor encoder 184 is used for monitoring and controlling the position of the toggle support 130 and the interval L. The toggle support position detector for detecting the position of the toggle support 130 and the interval detector for detecting the interval L are not limited to the mold thickness adjustment motor encoder 184, and a general detector may be used.

The mold clamping device 100 may include a mold temperature regulator that regulates the temperature of the mold device 800. The mold device 800 has a flow path for a temperature control medium therein. The mold temperature regulator regulates the temperature of the mold device 800 by regulating the temperature of the temperature regulating medium supplied to the flow path of the mold device 800.

The mold clamping device 100 of the present embodiment horizontal type in which the mold opening/closing direction is a horizontal direction, but may be a vertical type in which the mold opening/closing direction is a vertical direction.

The mold clamping device 100 of the present embodiment includes the mold clamping motor 160 as a drive source, but may include a hydraulic cylinder instead of the mold clamping motor 160. The mold clamping device 100 may include a linear motor for opening and closing the mold and an electromagnet for clamping the mold.

### (Ejector Device)

In the description of the ejector device 200, as in the description of the mold clamping device 100, the moving direction (e.g., the X-axis positive direction) of the movable platen 120 at the time of mold closing is described as the front, and the moving direction (e.g., the X-axis negative direction) of the movable platen 120 at the time of mold opening is described as the rear side.

The ejector device 200 is attached to the movable platen 120 and moves back and forth together with the movable platen 120. The ejector device 200 includes an ejector rod 210 that ejects a molded article from the mold device 800, and a drive mechanism 220 that moves the ejector rod 210 in the moving direction (X-axis direction) of the movable platen 120.

The ejector rod 210 is disposed in a through-hole of the movable platen 120 in a retractable manner. The front end portion of the ejector rod 210 is in contact with an ejector plate 826 of the movable mold 820. The front end portion of the ejector rod 210 may be connected to the ejector plate 826 or may not be connected to the ejector plate 826.

The drive mechanism 220 includes, for example, an ejector motor, and a motion conversion mechanism that converts a rotational motion of the ejector motor into a linear motion of the ejector rod 210. The motion conversion mechanism includes a screw shaft and a screw nut screwed to the screw shaft. Balls or rollers may be interposed between the screw shaft and the screw nut.

The ejector device 200 performs an ejection process under the control of the control device 700. In the ejection process, the ejector rod 210 is moved forward from the standby position to the ejection position at a set moving speed, whereby the ejector plate 826 is moved forward to eject the molded article. Thereafter, the ejector motor is driven to move the ejector rod 210 backward at a set moving speed, and the ejector plate 826 is moved backward to the original standby position.

The position and the moving speed of the ejector rod 210 are detected by using, for example, an ejector motor encoder. The ejector motor encoder detects the rotation of the ejector motor and sends a signal indicating the detection result to the control device 700. The ejector rod position detector for detecting the position of the ejector rod 210 and the ejector rod moving speed detector for detecting the moving speed of the ejector rod 210 are not limited to the ejector motor encoder, and a general detector may be used.

### (Injection Device)

In the description of the injection device 300, unlike the description of the mold clamping device 100 and the description of the ejector device 200, the moving direction of the screw 330 during filling (e.g., the X-axis negative direction) is referred to as the front, and the moving direction of the screw 330 during measurement (e.g., the X-axis positive direction) is referred to as the rear side.

The injection device 300 is installed on a slide base 301, and the slide base 301 is disposed in a retractable manner with respect to an injection device frame 920. The injection device 300 is disposed in a retractable manner with respect to the mold device 800. The injection device 300 touches the mold device 800 and fills the cavity space 801 in the mold device 800 with the molding material measured in a cylinder 310. The injection device 300 includes, for example, the cylinder 310 that heats the molding material, a nozzle 320 provided at a front end portion of the cylinder 310, a screw 330 disposed in the cylinder 310 in a rotatable and retractable manner, a measuring motor 340 that rotates the screw 330, an injection motor 350 that moves the screw 330 back and forth, and a load detector 360 that detects a load transmitted between the injection motor 350 and the screw 330.

The cylinder 310 heats the molding material supplied from a supply port 311 to the inside. The molding material includes, for example, a resin. The molding material is formed in a pellet shape, for example, and is supplied to the supply port 311 in a solid state. The supply port 311 is formed in a rear portion of the cylinder 310. A cooler 312 such as a water-cooled cylinder is provided on the outer periphery of the rear portion of the cylinder 310. A heater 313 such as a band heater and a temperature detector 314 are provided on the outer periphery of the cylinder 310 in front of the cooler 312.

The cylinder 310 is divided into a plurality of zones in the axial direction (e.g., the X-axis direction) of the cylinder 310. The heater 313 and the temperature detector 314 are provided in each of the plurality of zones. A set temperature is set for each of the plurality of zones, and the control device 700 controls the heater 313 such that the temperature detected by the temperature detector 314 becomes the set temperature.

The nozzle 320 is provided at the front end portion of the cylinder 310 and is pressed against the mold device 800. The heater 313 and the temperature detector 314 are provided on the outer periphery of the nozzle 320. The control device 700 controls the heater 313 such that the detected temperature of the nozzle 320 becomes the set temperature.

The screw 330 is disposed in the cylinder 310 in a rotatable and retractable manner. When the screw 330 is rotated, the molding material is fed forward along spiral grooves of the screw 330. The molding material is gradually melted by the heat from the cylinder 310 while being fed forward. As the liquid molding material is fed to the front side of the screw 330 and accumulated in the front portion of the cylinder 310, the screw 330 is moved backward. Thereafter, when the screw 330 is advanced, the liquid molding material accumulated in front of the screw 330 is injected from the nozzle 320 and is filled into the mold device 800.

A backflow prevention ring 331 is attached to the front side of the screw 330 in a retractable manner as a backflow prevention valve that prevents backflow of the molding material from the front side to the rear side of the screw 330 when the screw 330 is pushed forward.

When the screw 330 is advanced, the backflow prevention ring 331 is pushed rearward by the pressure of the molding material in front of the screw 330, and is retracted relative to the screw 330 to a closing position (see FIG. 2) at which the backflow prevention ring 331 closes the flow path of the molding material. This prevents the molding material accumulated in front of the screw 330 from flowing backward.

On the other hand, when the screw 330 is rotated, the backflow prevention ring 331 is pushed forward by the pressure of the molding material fed forward along the spiral grooves of the screw 330, and moves forward relative to the screw 330 to an open position (see FIG. 1) at which the flow path of the molding material is opened. Thus, the molding material is fed to the front side of the screw 330.

The backflow prevention ring 331 may be either a co-rotation type that rotates together with the screw 330 or a non-co-rotation type that does not rotate together with the screw 330.

The injection device 300 may include a drive source that moves the backflow prevention ring 331 back and forth between the open position and the closed position with respect to the screw 330.

The measuring motor 340 rotates the screw 330. The drive source for rotating the screw 330 is not limited to the measuring motor 340, and may be, for example, a hydraulic pump.

The injection motor 350 moves the screw 330 back and forth. A motion conversion mechanism or the like for converting the rotational motion of the injection motor 350 into the linear motion of the screw 330 is provided between the injection motor 350 and the screw 330. The motion conversion mechanism includes, for example, a screw shaft and a screw nut screwed to the screw shaft. Balls, rollers, or the like may be provided between the screw shaft and the screw nut. The drive source for advancing and retracting the screw 330 is not limited to the injection motor 350, and may be, for example, a hydraulic cylinder.

The load detector 360 detects a load transmitted between the injection motor 350 and the screw 330. The detected load is converted into a pressure by the control device 700. The load detector 360 is provided in a load transmission path between the injection motor 350 and the screw 330, and detects a load acting on the load detector 360.

The load detector 360 sends a signal of the detected load to the control device 700. The load detected by the load detector 360 is converted into a pressure acting between the screw 330 and the molding material, and is used for controlling or monitoring a pressure received by the screw 330 from the molding material, a back pressure to the screw 330, a pressure acting on the molding material from the screw 330, and the like.

The pressure detector for detecting the pressure of the molding material is not limited to the load detector 360, and a general pressure detector may be used. For example, a nozzle pressure sensor or a mold internal pressure sensor may be used. The nozzle pressure sensor is installed in the nozzle 320. The mold internal pressure sensor is installed inside the mold device 800.

The injection device 300 performs a measuring process, a filling process, a pressure holding process, and the like under the control of the control device 700. The filling process and the pressure holding process may be collectively referred to as an injection process.

In the measuring process, the measuring motor 340 is driven to rotate the screw 330 at a set rotation speed, and the molding material is fed forward along the spiral grooves of the screw 330. Accordingly, the molding material is gradually melted. As the liquid molding material is fed to the front side of the screw 330 and accumulated in the front portion of the cylinder 310, the screw 330 is moved backward. The rotation speed of the screw 330 is detected by using, for example, the measuring motor encoder 341. The measuring motor encoder 341 detects the rotation of the measuring motor 340 and sends a signal indicating the detection result to the control device 700. The screw rotational speed detector for detecting the rotational speed of the screw 330 is not limited to the measuring motor encoder 341, and a general detector may be used.

In the measuring process, in order to limit the rapid retract of the screw 330, the injection motor 350 may be driven to apply a set back pressure to the screw 330. The back pressure to the screw 330 is detected by using, for example, the load detector 360. When the screw 330 retracts to the measuring completion position and a predetermined amount of the molding material is accumulated in front of the screw 330, the measuring process is completed.

The position and the rotation speed of the screw 330 in the measuring process are collectively set as a series of setting conditions. For example, a measurement start position, a rotational speed switching position, and a measurement completion position are set. These positions are disposed in this order from the front side to the rear side, and represent the start point and the end point of the section in which the rotation speed is set. The rotation speed is set for each section. The rotational speed switching position may be one or more. The rotational speed switching position may not be set. Further, the back pressure is set for each section.

In the filling process, the injection motor 350 is driven to move the screw 330 forward at a set moving speed, and the liquid molding material accumulated in front of the screw 330 is filled in the cavity space 801 in the mold device 800. The position and the moving speed of the screw 330 are detected by using, for example, the injection motor encoder 351. The injection motor encoder 351 detects the rotation of the injection motor 350, and sends a signal indicating the detection result to the control device 700. When the position of the screw 330 reaches the set position, switching from the filling process to the pressure holding process (so-called “V/P switching”) is performed. The position where the V/P switching is performed is also referred to as a V/P switching position. The set moving speed of the screw 330 may be changed according to the position of the screw 330, time, or the like.

The position and the moving speed of the screw 330 in the filling process are collectively set as a series of setting conditions. For example, the filling start position (also referred to as “injection start position”) is set. The moving speed switching position and the V/P switching position are set. These positions are disposed in this order from the rear side to the front side and represent the start point and the end point of the section in which the moving speed is set. A moving speed is set for each section. The number of the moving speed switching positions may be one or more. The moving speed switching position may not be set.

The upper limit value of the pressure of the screw 330 is set for each section in which the moving speed of the screw 330 is set. The pressure of the screw 330 is detected by the load detector 360. When the pressure of the screw 330 is equal to or lower than the set pressure, the screw 330 is moved forward at the set moving speed. On the other hand, when the pressure of the screw 330 exceeds the set pressure, the screw 330 is advanced at a moving speed lower than the set moving speed such that the pressure of the screw 330 becomes equal to or lower than the set pressure for the purpose of protecting the mold.

Note that, after the position of the screw 330 reaches the V/P switching position in the filling process, the screw 330 may be temporarily stopped at the V/P switching position, and then the V/P switching may be performed. Immediately before the V/P switching, the screw 330 may be advanced or retracted at a very low speed instead of stopping the screw 330. Further, the screw position detector for detecting the position of the screw 330 and the screw moving speed detector for detecting the moving speed of the screw 330 are not limited to the injection motor encoder 351, and a general detector may be used.

In the pressure holding process, the injection motor 350 is driven to push the screw 330 forward, and the pressure of the molding material at the front end portion of the screw 330 (hereinafter, also referred to as “holding pressure”) is increased. The molding material remaining in the cylinder 310 is pushed toward the mold device 800. The molding material can be replenished to compensate shortages caused by the cooling shrinkage in the mold device 800. The holding pressure is detected by using, for example, the load detector 360. The set value of the holding pressure may be changed according to the elapsed time from the start of the pressure holding process. A plurality of holding pressures and a plurality of holding times for holding the holding pressures in the pressure holding process may be set, and may be collectively set as a series of setting conditions. In the pressure holding process, the molding material in the cavity space 801 in the mold device 800 is gradually cooled, and when the pressure holding process is completed, the inlet of the cavity space 801 is closed by the solidified molding material. This state is called a gate seal, and the backflow of the molding material from the cavity space 801 is prevented. After the pressure holding process, the cooling process is started. In the cooling process, the molding material in the cavity space 801 is solidified. In order to shorten the molding cycle time, the measuring process may be performed during the cooling process.

The injection device 300 of the present embodiment is of an in-line screw type, but may be of a pre-plasticizing type or the like. The pre-plasticizing injection device supplies a molding material melted in a plasticizing cylinder to an injection cylinder, and injects the molding material from the injection cylinder into the mold device. In the plasticizing cylinder, a screw is disposed in a rotatable and non-retractable manner, or a screw is disposed in a rotatable and retractable manner. On the other hand, a plunger is disposed in the injection cylinder in a retractable manner.

Further, the injection device 300 of the present embodiment is a horizontal type in which the axial direction of the cylinder 310 is the horizontal direction, but may be a vertical type in which the axial direction of the cylinder 310 is the vertical direction. The mold clamping device combined with the vertical injection device 300 may be a vertical type or a horizontal type. Similarly, the mold clamping device combined with the horizontal injection device 300 may be a horizontal type or a vertical type.

### (Moving Device)

In the description of the moving device 400, as in the description of the injection device 300, the moving direction (e.g., the X-axis negative direction) of the screw 330 during filling is referred to as the front side, and the moving direction (e.g., the X-axis positive direction) of the screw 330 during measurement is referred to as the rear side.

The moving device 400 moves the injection device 300 back and forth with respect to the mold device 800. The moving device 400 presses the nozzle 320 against the mold device 800 to generate a nozzle touch pressure. The moving device 400 includes a hydraulic pump 410, a motor 420 as a drive source, a hydraulic cylinder 430 as a hydraulic actuator, and the like.

The hydraulic pump 410 has a first port 411 and a second port 412. The hydraulic pump 410 is a pump capable of rotating in both directions. The hydraulic pump 410 generates a hydraulic pressure by switching the rotation direction of the motor 420 to suck a working fluid (e.g., oil) from one of the first port 411 and the second port 412 and discharge the working fluid from the other. The hydraulic pump 410 can also suck the working fluid from a tank and discharge the working fluid from either one of the first port 411 and the second port 412.

The motor 420 operates the hydraulic pump 410. The motor 420 drives the hydraulic pump 410 in a rotational direction and with a rotational torque corresponding to a control signal from the control device 700. The motor 420 may be an electric motor or an electric servo motor.

The hydraulic cylinder 430 includes a cylinder main body 431, a piston 432, and a piston rod 433. The cylinder main body 431 is fixed to the injection device 300. The piston 432 divides the interior of the cylinder main body 431 into a front chamber 435 as a first chamber and a rear chamber 436 as a second chamber. The piston rod 433 is fixed relative to the fixed platen 110.

The front chamber 435 of the hydraulic cylinder 430 is connected to the first port 411 of the hydraulic pump 410 via a first flow path 401. The working fluid discharged from the first port 411 is supplied to the front chamber 435 via the first flow path 401, whereby the injection device 300 is pushed forward. The injection device 300 is advanced, and the nozzle 320 is pressed against the fixed mold 810. The front chamber 435 functions as a pressure chamber that generates a nozzle touch pressure of the nozzle 320 by the pressure of the working liquid supplied from the hydraulic pump 410.

On the other hand, the rear chamber 436 of the hydraulic cylinder 430 is connected to the second port 412 of the hydraulic pump 410 via the second flow path 402. The hydraulic fluid discharged from the second port 412 is supplied to the rear chamber 436 of the hydraulic cylinder 430 via the second flow path 402, whereby the injection device 300 is pushed rearward. The injection device 300 is retracted, and the nozzle 320 is separated from the fixed mold 810.

In the present embodiment, the moving device 400 includes the hydraulic cylinder 430, but the configuration of the present disclosure is not limited to this example. For example, instead of the hydraulic cylinder 430, an electric motor and a motion conversion mechanism that converts the rotational motion of the electric motor into the linear motion of the injection device 300 may be used.

### (Control Device)

The control device 700 is configured by, for example, a computer, and includes circuitry including a central processing unit (CPU) 701, a storage medium 702 such as a memory, an input interface (I/F) 703, an output interface (I/F) 704, and a communication interface (I/F) 705 as illustrated in FIGS. 1 and 2. The control device 700 performs various controls by causing the CPU 701 to execute a program stored in the storage medium 702. The control device 700 receives a signal from the outside through the input I/F 703 and transmits a signal to the outside through the output I/F 704. The control device 700 transmits information to an external device via the communication I/F 705.

The control device 700 repeatedly performs the measuring process, the mold closing process, the pressurizing process, the mold clamping process, the filling process, the pressure holding process, the cooling process, the depressurizing process, the mold opening process, the ejection process, and the like, and thus repeatedly produces a molded article. A series of operations for obtaining a molded article, for example, an operation from the start of a measuring process to the start of the next measuring process is also referred to as a “shot” or a “molding cycle”. The time required for one shot is also referred to as “molding cycle time” or “cycle time”.

One molding cycle includes, for example, a measuring process, a mold closing process, a pressurizing process, a mold clamping process, a filling process, a pressure holding process, a cooling process, a depressurizing process, a mold opening process, and an ejection process in this order. The order here is the order of the start of each process. The filling process, the pressure holding process, and the cooling process are performed during the mold clamping process. The start of the mold clamping process may match the start of the filling process. The completion of the depressurizing process matches the start of the mold opening process.

A plurality of processes may be performed simultaneously for the purpose of shortening the molding cycle time. For example, the measuring process may be performed during the cooling process of a previous molding cycle, or may be performed during the mold clamping process. In this case, the mold closing process may be performed at the beginning of the molding cycle. The filling process may be started during the mold closing process. The ejection process may be started during the mold opening process. In a case where an opening/closing valve that opens and closes the flow path of the nozzle 320 is provided, the mold opening process may be started during the measuring process. This is because even if the mold opening process is started during the measuring process, the molding material does not leak from the nozzle 320 as long as the opening/closing valve closes the flow path of the nozzle 320.

One molding cycle may include a process other than the measuring process, the mold closing process, the pressurizing process, the mold clamping process, the filling process, the pressure holding process, the cooling process, the depressurizing process, the mold opening process, and the ejection process.

For example, after the completion of the pressure holding process and before the start of the measuring process, a pre-measuring suck-back process of retracting the screw 330 to a preset measuring start position may be performed. This can reduce the pressure of the molding material accumulated in front of the screw 330 before the start of the measuring process, and can prevent the rapid retract of the screw 330 at the start of the measuring process.

After the completion of the measuring process and before the start of the filling process, a post-measuring suck-back process of retracting the screw 330 to a preset filling start position (also referred to as an “injection start position”) may be performed. This can reduce pressure of the molding material accumulated in front of the screw 330 before the start of the filling process, and can prevent the leakage of the molding material from the nozzle 320 before the start of the filling process.

The control device 700 is connected to an operation device 750 that receives an input operation by an operator and a display device 760 that displays a screen. The operation device 750 and the display device 760 may be configured by, for example, a touch panel 770 and may be integrated. The touch panel 770 as the display device 760 displays a screen under the control of the control device 700. For example, the display device 760 may include a liquid crystal panel (an example of a display unit) for displaying a screen. The display unit is not limited to the liquid crystal panel, and another display device such as an organic EL may be used. For example, information such as the setting of the injection molding machine 10 and the current state of the injection molding machine 10 may be displayed on the screen of the touch panel 770. The touch panel 770 can receive an operation in a displayed screen area. In addition, for example, an operation unit such as a button or an input field for receiving an input operation by an operator may be displayed in the screen area of the touch panel 770. The touch panel 770 as the operation device 750 detects an input operation on the screen by the operator and outputs a signal corresponding to the input operation to the control device 700. Thus, for example, the operator can perform setting (including input of a setting value) of the injection molding machine 10 by operating the operation unit provided on the screen while checking the information displayed on the screen. Further, the operator can operate the operation unit provided on the screen to cause the injection molding machine 10 to perform an operation corresponding to the operation unit. Note that the operation of the injection molding machine 10 may be, for example, the operation (including stopping) of the mold clamping device 100, the ejector device 200, the injection device 300, the moving device 400, or the like. The operation of the injection molding machine 10 may be switching of a screen displayed on the touch panel 770 as the display device 760.

Note that the operation device 750 and the display device 760 of the present embodiment are described as being integrated as the touch panel 770, but may be provided independently. A plurality of operation devices 750 may be provided. The operation device 750 and the display device 760 are disposed on the operation side (Y-axis negative direction) of the mold clamping device 100 (more specifically, the fixed platen 110).

### Embodiment

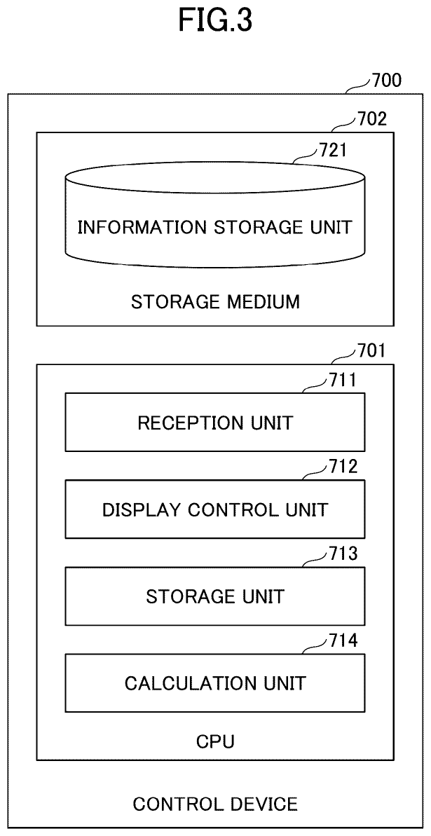

FIG. 3 is a diagram illustrating components of the control device 700 of the injection molding machine 10 according to the present embodiment as functional blocks. Each functional block illustrated in FIG. 3 is conceptual, and is not necessarily physically configured as illustrated in the figure. All or some of the functional blocks may be configured to be functionally or physically distributed or integrated in any units. All or some of the processing functions performed by the functional blocks of the control device 700 are implemented by a program executed in the CPU 701. Alternatively, each functional block may be implemented as hardware by wired logic. As illustrated in FIG. 3, the CPU 701 of the control device 700 includes a reception unit 711, a display control unit 712, a storage unit 713, and a calculation unit 714. The control device 700 includes an information storage unit 721 in the storage medium 702.

The information storage unit 721 stores log information indicating actual values that are detection results by various sensors (an example of a detection unit).

The display control unit 712 performs control to display data such as a display screen on the touch panel 770. The display control unit 712 according to the present embodiment may output, to the touch panel 770, a display screen on which actual values detected in each process of the molding process by the injection molding machine 10 are displayed on a per shot basis. Note that, in the present embodiment, an example in which a display screen or the like is output to the touch panel 770 will be described, but the output destination of data is not limited to the touch panel 770. For example, the display control unit 712 may output data of a display screen or the like to a mobile communication device (not illustrated) connected via a network.

The reception unit 711 receives a user operation from the touch panel 770 via the input I/F 703.

The storage unit 713 stores actual values during molding, the statistical values, and the like in the information storage unit 721 as log information. The operation for storing the log information is performed on the log information screen displayed by the display control unit 712. The specific operation will be described later.

The calculation unit 714 calculates statistical values based on the actual values obtained by the various sensors and the like in order to display the statistical values on the log information screen.

In the present embodiment, a case where an operation is performed on a display screen displayed on the touch panel 770 of the injection molding machine 10 will be described. The reception unit 711 according to the present embodiment can receive selection of any area displayed on the touch panel 770 and input of numerical values or characters via the operation device 750 of the touch panel 770.

The display control unit 712 according to the present embodiment displays, for example, a log information displays screen that actual values during molding, statistical values, and the like as log information.

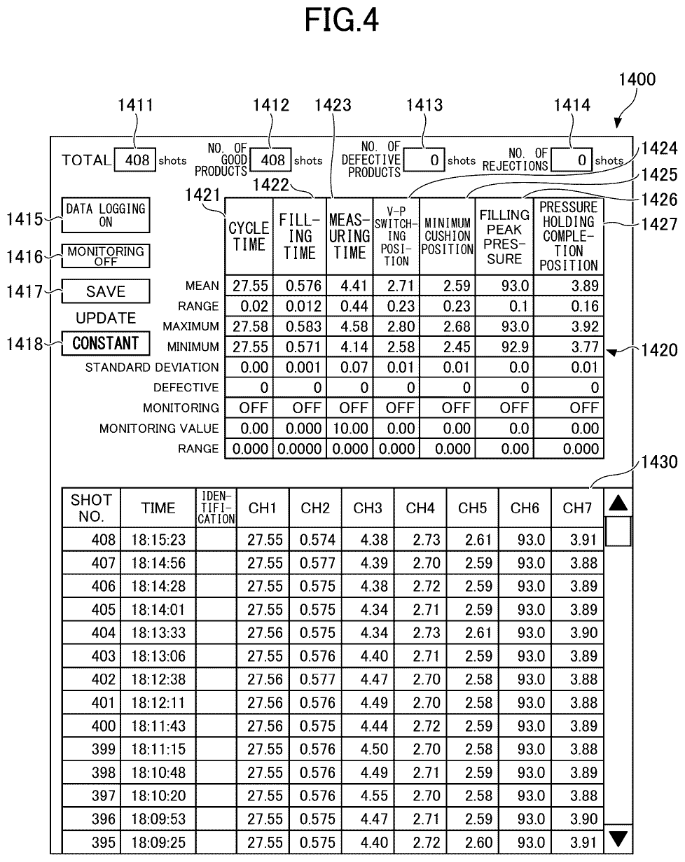

FIG. 4 is a diagram illustrating a log information screen output by the display control unit 712 according to the present embodiment.

The log information screen 1400 illustrated in FIG. 4 includes a total 1411, the number of good products 1412, the number of defective products 1413, the number of rejections 1414, a logging button 1415, a monitoring setting button 1416, a save button 1417, an update button 1418, a statistics list 1420, and a result list 1430.

The statistics list 1420 illustrates statistical information (e.g., a mean, a range, a maximum, a minimum, and a standard deviation) for each of the setting fields 1421 to 1427. The contents displayed in the setting fields 1421 to 1427 can be set by a user. In the present embodiment, items displayed in the setting fields 1421 to 1427 can be displayed and monitored, and log information can be stored. The monitoring in the present embodiment represents determination of whether a product is a good product based on predetermined criteria.

The statistical information is information calculated based on the actual values (examples of parameters) obtained every time a molded article is manufactured by performing injection molding with the injection molding machine 10, and includes, for example, a mean, a range, a maximum, a minimum, and a standard deviation calculated for each of the setting fields 1421 to 1427 in the statistics list 1420. Note that the present embodiment illustrates an example of the statistical information, and statistical information other than the mean, the range, the maximum, the minimum, and the standard deviation, for example, an integral value or the like may be used. In addition, the items for which the statistical information is calculated are not limited to the items set in the setting fields 1421 to 1427, and may be other items.

The calculation unit 714 calculates the statistical information by including the actual values (examples of parameters) obtained in the injection molding in the range indicated in the result list 1430 as calculation targets. Then, the display control unit 712 displays the statistical information calculated by the calculation unit 714 in the statistics list 1420.

The “monitoring”, the “monitoring values”, and the “range” of the statistics list 1420 are information for determining whether a molded article in the setting field is defective.

When the monitoring of the statistics list 1420 is “OFF”, the control device 700 does not perform monitoring, and when the monitoring is “ON”, the control device 700 performs monitoring. In the case of “ON”, the control device 700 determines whether the measured actual value in the item indicated in the setting field satisfies the criteria indicated by “monitored value” and “range” (e.g., whether the measured actual value is included in “range” with “monitored value” as the median). The switching of the monitoring is performed by a monitoring setting button 1406. The “defective” of the statistics list 1420 indicates the number of molded articles that do not satisfy the criteria indicated by the “monitoring value” and the “range”.

The “cycle time” in the setting field 1421, the “filling time” in the setting field 1422, and the “measuring time” in the setting field 1423 are items set to monitor the time required for the cycle, the filling, and the measurement.

The “V-P switching position” of the setting field 1424 is an item set to monitor the position (V/P switching position) of the screw 330 when a process is switched from the filling process to the pressure holding process. A setting field 1425 of “minimum cushion position” is an item set to monitor the position of the screw 330 when the screw moves to the forefront when applying pressure after filling the molding material into the mold device 800. The “filling peak pressure” in the setting field 1426 is an item set for monitoring the peak value of the pressure when the molding material is filled. The “pressure holding completion position” of the setting field 1427 is an item set to monitor the position of the screw 330 at the time of completion of the pressure holding.

The setting fields 1421 to 1427 can be changed to items that the user desires to monitor. The description of the changing method is omitted.

The result list 1430 represents a list of setting information (e.g., setting values) in the items set in the setting fields 1421 to 1427 or actual values measured by various sensors for each shot. The items set in the setting fields 1421 to 1427 are set from “CH1” to “CH7”. Further, for each shot, “shot number”, “time” when injection molding is performed, and “identification” of injection molding are associated as information indicating the corresponding shot.

The logging button 1415 is a button for receiving selection of whether to save the actual values illustrated in the result list 1430 as log information. When the logging button 1415 is pressed (“data logging ON” is displayed), the storage unit 713 saves information (e.g., actual values by various sensors) indicated in the result list 1430 and the like in the information storage unit 721 as log information.

The monitoring setting button 1416 is a button for receiving whether to monitor according to the items to be monitored in the statistics list 1420. When the monitoring setting button 1416 is pressed (“monitoring ON” is displayed), whether the shot is defective is monitored for each shot, and the monitoring result is included in the log information. When the monitoring setting button 1416 is pressed, monitoring for each of the setting fields 1421 to 1427 of the statistics list 1420 can be switched to “OFF” or “ON”. The save button 1417 is a button for receiving whether to save the statistical value (e.g., mean, range, maximum, minimum, standard deviation, or the like) for each of the setting fields 1421 to 1427. When the save button 1417 is pressed, the storage unit 713 saves the statistical values for each of the setting fields 1421 to 1427 and the actual values indicated in the result list 1430 in the information storage unit 721 as log information. In the present embodiment, an example in which the actual values are displayed in the setting fields 1421 to 1427 of the statistics list 1420 and the result list 1430 has been described, but the configuration of the present disclosure is not limited to the display of the actual values. For example, setting values may be displayed in the setting fields 1421 to 1427 of the statistics list 1420 and the result list 1430. In this case, when the save button 1417 is pressed, the storage unit 713 may save the setting values. The update button 1418 is a button for receiving whether to update the statistics list 1420 and the result list 1430 every time injection molding by the injection molding machine 10 is completed. When the update button 1418 is pressed (“constant” is displayed), the statistics list 1420 and the result list 1430 are updated every time injection molding by the injection molding machine 10 is completed.

The total 1411 indicates the number of molded articles molded by the injection molding machine 10. The number of good products 1412 indicates the number of molded articles determined to be good based on the “monitoring”, the “monitoring values”, and the “range”. The number of defective products 1413 indicates the number of molded articles determined to be defective based on the “monitoring”, the “monitoring values”, and the “range”. The number of rejections 1414 indicates the number of rejected molded articles.

As described above, when a plurality of molded articles are produced from a molding material by the injection molding machine 10 (production device), the display control unit 712 of the control device 700 displays, for each molded article, the actual values (examples of detection results) detected by various sensors in a process of producing the molded articles in the result list 1430 of the display device 760. In the statistics list 1420 of the present embodiment, a maximum value, a minimum value, or the like (an example of a detection result extracted by a statistical procedure) is displayed for each of the setting fields 1421 to 1427 (respective items into which the detection results are classified) so as to be selectable via the touch panel 770.

For example, when the reception unit 711 receives selection of the maximum value or the minimum value of the statistics list 1420, the display control unit 712 displays, in the result list 1430, a row (record) indicating a first molded article for which the selected maximum value or minimum value is detected, a record indicating a molded article molded by the injection molding machine 10 before the first molded article, and a record indicating a molded article molded by the injection molding machine 10 after the first molded article.

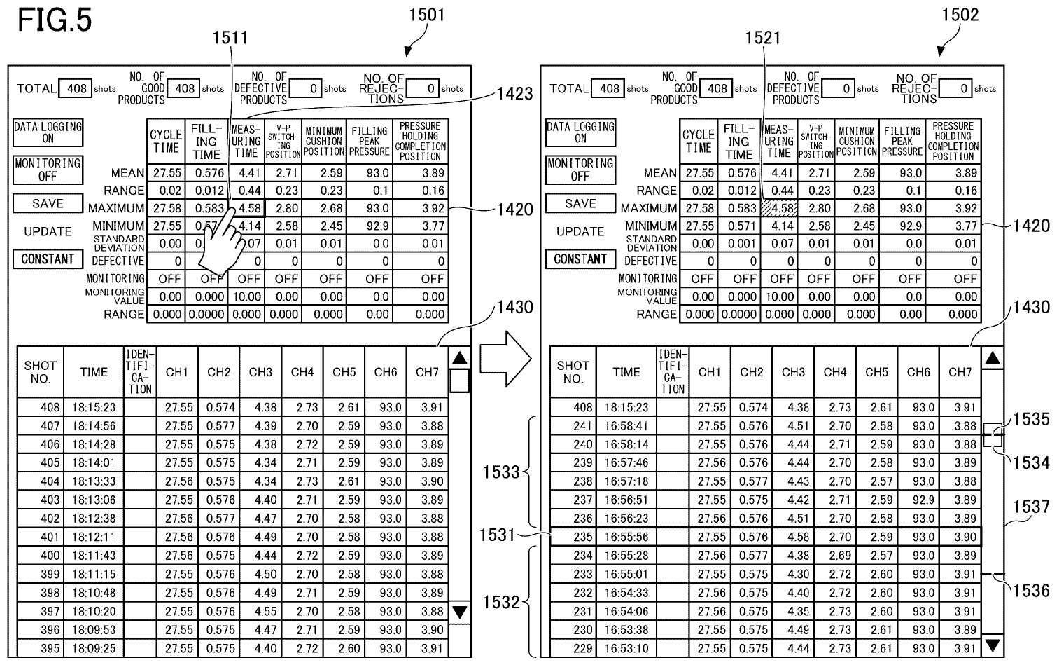

Next, a case where selection of the maximum value or the minimum value of the statistics list 1420 is received will be described. FIG. 5 is a diagram illustrating an example of a change in the screen when selection of the maximum value in the column of the setting field 1423 of the statistics list 1420 of the log information screen according to the present embodiment is received.

A screen 1501 of FIG. 5 is a log information screen including a statistics list 1420. The operator refers to the screen 1501 of FIG. 5 and presses a cell 1511 indicating the maximum value in the column of the setting field 1423 of “measuring time” in order to check the situation when “measuring time” reaches the maximum value “4.58”.

As a result, the screen 1501 changes to a screen 1502. Specifically, the display control unit 712 performs scrolling control on a table of the result list (an example of the first display area) 1430 such that the record with the CH3 of “4.58” is located at the center of the result list 1430. The CH3 corresponds to the “measuring time”. Then, a record 1531 relating to the molded article having the “measuring time” of “4.58” is displayed at the center of the result list 1430 by the scrolling control.

The display control unit 712 displays a cell 1521 of the maximum value in the column of the setting field 1423 of the statistics list 1420 in a color different from that of the other cells. This enables the operator to recognize that the maximum value of the “measuring time” is selected.

The display control unit 712 displays positions 1535 and 1536 of the record in which the “measuring time” is “4.58” in the scroll bar 1537 of the result list 1430. Thus, it is possible to recognize that there are two molded articles having the “measuring time” of “4.58” and an approximate timing at which the molded article having the “measuring time” of “4.58” is molded. That is, the operator can recognize whether the timing at which the molded article having the “measuring time” of “4.58” is molded is sudden or continuous.

In the screen 1502, since a knob 1534 is present at a position where the position 1535 is the center, the record 1531 corresponding to the position 1535 is displayed at the center of the result list 1430.

On the screen 1502, records 1532 for six shots molded before the shot indicated by the record 1531 and records 1533 for six shots molded after the shot indicated by the record 1531 are displayed in the order of shots with the record 1531 in which the “measuring time” is the maximum value “4.58” as the center.

That is, when the operator checks a detection result of a molded article of which the “measuring time” is the maximum value “4.58”, the operator can also check detection results of molded articles for the six shots before and after the molded article.

Thus, the operator can check whether the “measuring time” is suddenly increased to the maximum value “4.58” or the measuring time is increased with the change of time.

That is, when the maximum value or the minimum value is obtained in any item while a molded article is formed, it may be difficult for the operator to identify the circumstances and situation of the detection result only by referring to the detection result of the molded article.

Therefore, in the present embodiment, when the reception unit 711 receives the selection of the maximum value of the “measuring time” from the operator, the display control unit 712 displays not only the record of the maximum value of “measuring time”, but also the records of the six shots before and after the record of the maximum value of “measuring time” based on a shot number indicated by the record of the maximum value of “measuring time” in the results list 1430.

This enables the operator to identify a change in the detection result of each shot until the “measuring time” reaches the maximum value and a change in the detection result of each shot after the “measuring time” reaches the maximum value. That is, the operator can identify the change in a situation in chronological order, such as a situation until the “measuring time” reaches the maximum value and a situation after the “measuring time” reaches the maximum value.

On the screen 1502, when the reception unit 711 receives an operation of moving the knob 1534 to the position 1536 from the operator, the display control unit 712 displays another record in which the “measuring time” has reached the maximum value.

In addition, on the screen 1502, when the reception unit 711 receives selection of the cell 1521 of the maximum value of the column of the setting field 1423 of the statistics list 1420 again, the display control unit 712 may perform scrolling such that another record of which the “measuring time” has reached the maximum value is displayed at the center of the result list 1430. As described above, in the present embodiment, the detection results of all the molded articles for which the “measuring time” has reached the maximum value can be checked, including the situations before and after the “measuring time” has reached the maximum value.

In the example illustrated in FIG. 5, the detection results of the molded article for which the selected statistical information is detected are displayed together with the detection results for the six shots before and after the molded article. However, the present embodiment is not limited to the example in which the detection results of the six shots before and after the molded article are displayed. For example, detection results for seven or more shots before and after the current shot may be displayed, or detection results for five or less shots before and after the current shot may be displayed. That is, the control device 700 according to the present embodiment may display, on the display device 760, detection results of the first molded article (an example of a first product) for which the selected statistical information is detected, together with detection results of a molded article (an example of a second product) molded at least before the first molded article and detection results of a molded article (an example of a third product) molded at least after the first molded article.

In the present embodiment, the above-described record is displayed in the center of the result list 1430 by performing scrolling control on the result list. However, the control of the table of the result list 1430 is not limited to the scrolling control, and for example, the display control unit 712 may perform jumping control to move the record described above to the center.

### Modification of Embodiment

In the above-described embodiment, an example in which the detection results of the molded article corresponding to the statistical information selected in the statistics list 1420 are displayed in the result list 1430 has been described. However, the above-described embodiment is not limited to the configuration of displaying the actual results in the result list 1430. Therefore, in a modification of the embodiment, an example in which the detection results of the molded article corresponding to the selected statistical information are displayed in a pop-up manner will be described.

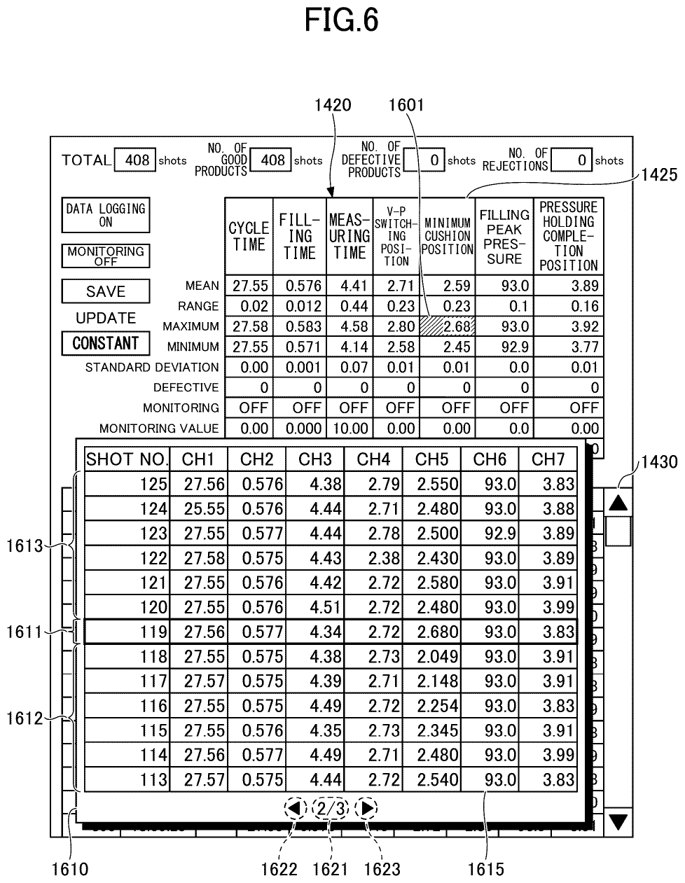

FIG. 6 is a diagram illustrating an example of a log information screen output by the display control unit 712 according to the present modification. In the example illustrated in FIG. 6, the reception unit 711 receives pressing of a cell 1601 indicating the maximum value (2.68) in the column of the setting field 1425 of “minimum cushion position”.

When the cell 1601 is pressed, the display control unit 712 displays a pop-up window 1610 separately from the result list 1430.

In the pop-up window 1610, a record 1611 having a CH5 of “2.680” is displayed at the center of the table 1615. Thus, the detection results of the molded article molded when the “minimum cushion position” corresponding to the CH5 becomes “2.680” is displayed.

In the pop-up window 1610, records 1612 for six shots molded before the shot indicated by the record 1611 and records 1613 for six shots molded after the shot indicated by the record 1611 are displayed in the order of shots with the record 1611 in which the “minimum cushion position” is the maximum value “2.680” as the center.

The display control unit 712 displays the cell 1601 of the maximum value in the column of the setting field 1425 of the statistics list 1420 in a color different from colors of the other cells. This enables the operator to recognize that the maximum value of the “minimum cushion position” is selected.

In addition, in the pop-up window 1610, in a case where a plurality of molded articles corresponding to the selected statistical information are present, the table to be displayed can be switched.

The pop-up window 1610 illustrated in FIG. 6 indicates that the detection results of the second molded article are displayed among the three molded articles in which the “minimum cushion position” is the maximum value “2.680”, as indicated by “⅔” in a page display field 1621.

Then, when the reception unit 711 receives the pressing of paging icons 1622 and 1623, the display control unit 712 switches the display to the display of the detection results of another article among the three molded articles in which the “minimum cushion position” is the maximum value “2.680”.

As described above, when the selection of the maximum value or the minimum value illustrated in the statistics list 1420 is received, the control device 700 according to the present modification displays the pop-up window 1610 different from the result list 1430, and displays the detection results of the first molded article having the maximum value of the “minimum cushion position” and the detection results of the molded articles for six shots each molded before and after the first molded article in the pop-up window 1610.

In the present modification, by displaying information relating to statistical information selected by the operator in the pop-up window 1610 different from the result list 1430, the same effect as the above-described embodiment is obtained, and in parallel with the checking of the current situation in the result list 1430, the situation when the statistical information selected is applied can be checked in the pop-up window 1610.

### Another Embodiment

In the above-described embodiment and modification, a case where selection is received from the statistical information illustrated in the statistics list 1420 has been described. However, the above-described embodiment is not limited to an example in which the selection for displaying the detection results is received from the statistics list 1420. Therefore, in another embodiment, an example in which selection is received from the result list 1430 will be described.

In the present embodiment, as in the embodiment, a log information screen including the statistics list 1420 and the result list 1430 as illustrated in FIG. 4 is displayed.

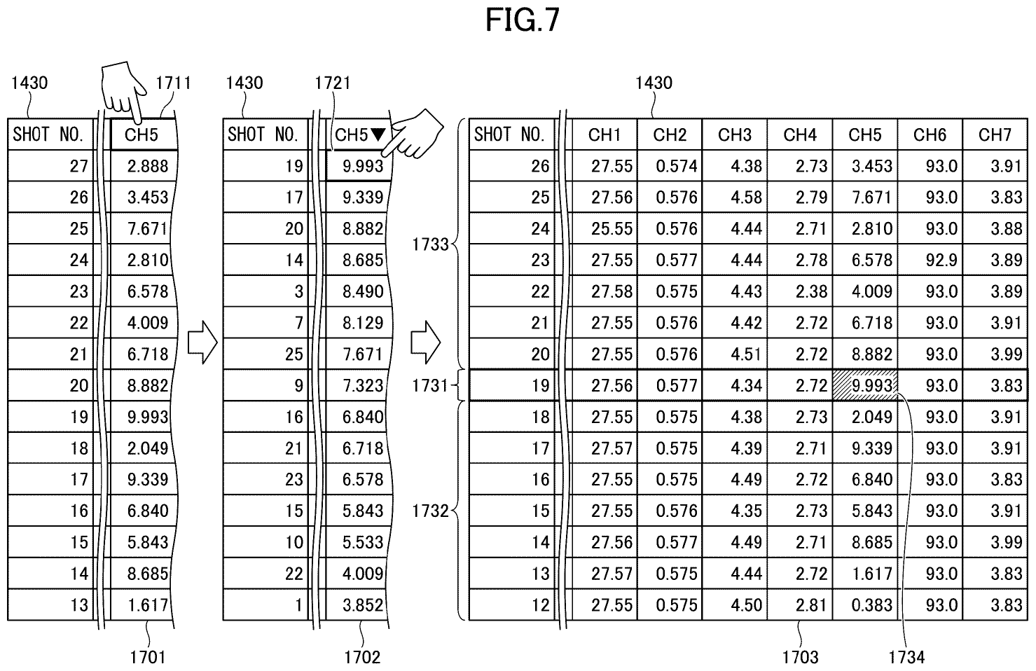

FIG. 7 is a diagram illustrating an example of a change in the screen when an operation of sorting the records by CH5 is received in the result list 1430 of the log information screen according to the present embodiment. It is assumed that the same display as that in FIG. 4 is presented except for the area displayed in FIG. 7. In the present embodiment, in the result list 1430, selection can be received for each of CH1 to CH7 by which the actual values are classified.

First, in a partial area 1701 of the screen of FIG. 7, shot numbers are displayed in chronological order. Then, the reception unit 711 receives the pressing of the cell 1711 of “CH5” in the result list 1430. Thus, the records of the molded articles are sorted based on the actual values indicated by “CH5” in the result list 1430.

In a partial area 1702 of the screen of FIG. 7, the result list 1430 after the actual values indicated by “CH5” are sorted in descending order is illustrated. Thus, the operator can identify the actual values indicated by “CH5” in descending order from the maximum value. In the example illustrated in FIG. 7, selection of each cell displayed in the result list 1430 (an example of selection of a detection result) can be received.

The partial area 1702 of FIG. 7 illustrates an example in which the actual values are sorted in descending order, but the embodiment of the present disclosure is not limited to this example in which the actual values are sorted in descending order. For example, when the reception unit 711 receives the pressing of the cell of “CH5” in the result list 1430 again, the display control unit 712 may display the result list 1430 in which the actual values are sorted in ascending order.

As described above, in the present embodiment, when selection of a predetermined item (e.g., CH1 to CH7) is received, the display control unit 712 sorts the actual values for each molded article in the predetermined item in ascending or descending order and displays the sorted actual values for each molded article in the predetermined item in ascending or descending order. The reception unit 711 can then receive selection of each of the actual values displayed in a sorted manner.

Then, the reception unit 711 receives selection of the cell 1721 having the maximum value “9.993” of the actual values displayed in the result list 1430.

A partial area 1703 in FIG. 7 indicates a partial area of the log information screen displayed by the display control unit 712 after the selection of the cell 1721 in the partial area 1702 is received.

In the partial area 1703, records 1733 for seven shots molded before the shot indicated by a record 1731 and records 1732 for seven shots molded after the shot indicated by the record 1731 are displayed in the order of shots with the record 1731 in which the maximum value of the actual value of “CH5” is “9.993” as the center.

In the example illustrated in FIG. 7, the cell 1734 of the actual value for which the selection is received is displayed in a color different from the other cells.

Thus, the operator can identify a change in the detection result of each shot until the “minimum cushion position” corresponding to the “CH5” reaches the maximum value and a change in the detection result of each shot after the “minimum cushion position” reaches the maximum value. The operator can identify changes in situations in chronological order, such as a situation until the “minimum cushion position” reaches the maximum value and a situation after the “minimum cushion position” reaches the maximum value.

In the present embodiment, when the operator selects a CH from the result list 1430, the operator can identify the actual values of the selected CH in ascending order or descending order, and can recognize a change in the situation based on the actual values by selecting these actual values.

### Modification of Another Embodiment

In another embodiment described above, an example in which the actual values of the item (e.g., “CH5”) for which the selection is received are sorted in descending order or ascending order and displayed in the result list 1430 has been described. However, another embodiment is not limited to the example in which the actual values of the item (e.g., “CH5”) for which the selection is received are sorted in descending order or ascending order. In a modification of another embodiment, an example in which the actual values of the item (e.g., “CH5”) for which the selection is received is filtered by the maximum value or minimum value (an example of a predetermined condition) will be described.

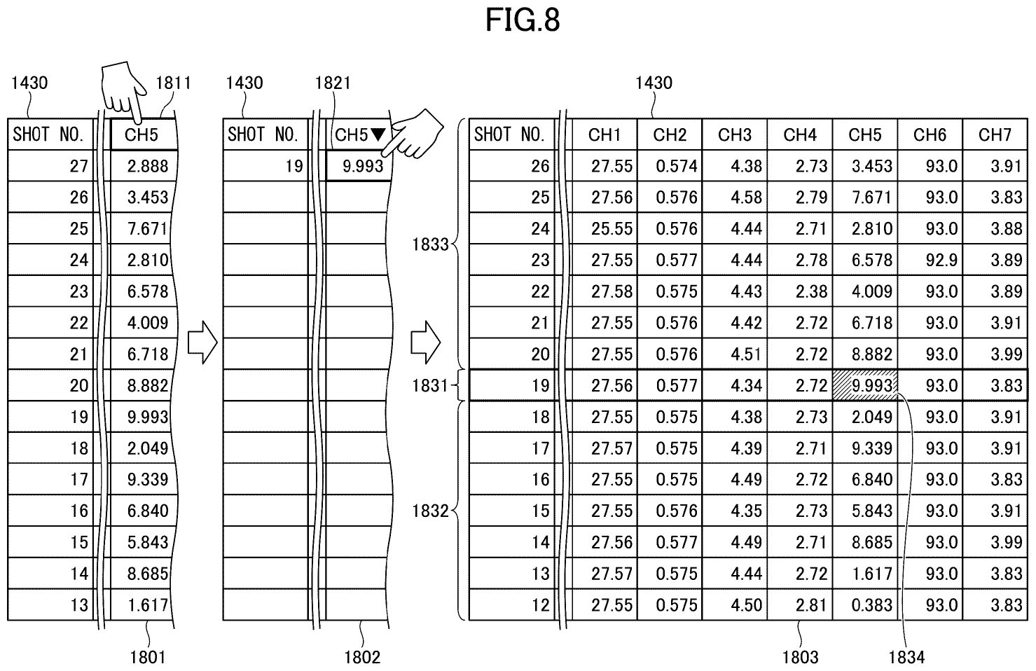

FIG. 8 is a diagram illustrating an example of a change in the screen when an operation of filtering by CH5 is received in the result list 1430 of the log information screen according to the present modification. It is assumed that the same display as that in FIG. 4 is presented except for the area displayed in FIG. 8.

First, in a partial area 1801 of the screen of FIG. 8, shot numbers are displayed in chronological order. Then, the reception unit 711 receives pressing of the cell 1811 of “CH5” in the result list 1430. As a result, the result list 1430 is filtered by the maximum value with respect to the actual values indicated by “CH5”.

In a partial area 1802 of the screen of FIG. 8, the result list 1430 after the actual values indicated by “CH5” are filtered by the maximum value is illustrated. Thus, the operator can identify the maximum value of the actual value indicated by “CH5”. In the example illustrated in FIG. 8, selection of each cell displayed in the result list 1430 can be received.

The partial area 1802 of FIG. 8 illustrates an example in which the actual values are filtered by the maximum value, but the embodiment of the present disclosure is not limited to the example in which the actual values are filtered by the maximum value. For example, when the reception unit 711 receives the pressing of the cell of “CH5” in the result list 1430 again, the display control unit 712 may filter the actual values by the minimum value and display the result list 1430.

As described above, in the present embodiment, when selection of the predetermined item (e.g., CH1 to CH7) is received, the display control unit 712 filters the actual values for each molded article in the predetermined item by the maximum value or minimum value and displays a filtered actual value. Then the reception unit 711 can receive selection of the displayed filtered actual value.

Then, the reception unit 711 receives selection of the cell 1821 in which the actual value displayed in the result list 1430 is the maximum value “9.993”.

A partial area 1803 in FIG. 8 indicates a partial area of the log information screen displayed by the display control unit 712 after selection of the cell 1821 in the partial area 1802 is received.

In the partial area 1803, records 1833 for seven shots molded before the shot indicated by a record 1831 and records 1832 for seven shots molded after the shot indicated by the record 1831 are displayed in the order of shots with the record 1831 in which the maximum value of the actual value in “CH5” is “9.993” as the center.

In the example illustrated in FIG. 8, the cell 1834 of the actual value for which the selection is received is displayed in a color different from the other cells.

Thus, in the present modification, the operator can identify a change in the detection result of each shot until the “minimum cushion position” corresponding to the “CH5” reaches the maximum value and a change in the detection result of each shot after the “minimum cushion position” reaches the maximum value, and thus, the same effect as in another embodiment described above can be obtained. In the present modification, the case where the filtering condition is the maximum value or the minimum value has been described. However, the present modification is not intended to limit the filtering condition to the maximum value or the minimum value, and other conditions may be used.

### Still Another Embodiment

In the above-described embodiments and modifications, the example in which the detection result of each shot is displayed in chronological order when the selection of the maximum value or the minimum value of the actual value detected by various sensors is received has been described. However, the above-described embodiments and modifications are not intended to limit the target of the selection to the maximum value or the minimum value of the actual value. Therefore, in the still another embodiment, an example of receiving selection of the shot number, in other words, an example of receiving selection of information for identifying a molded article will be described.

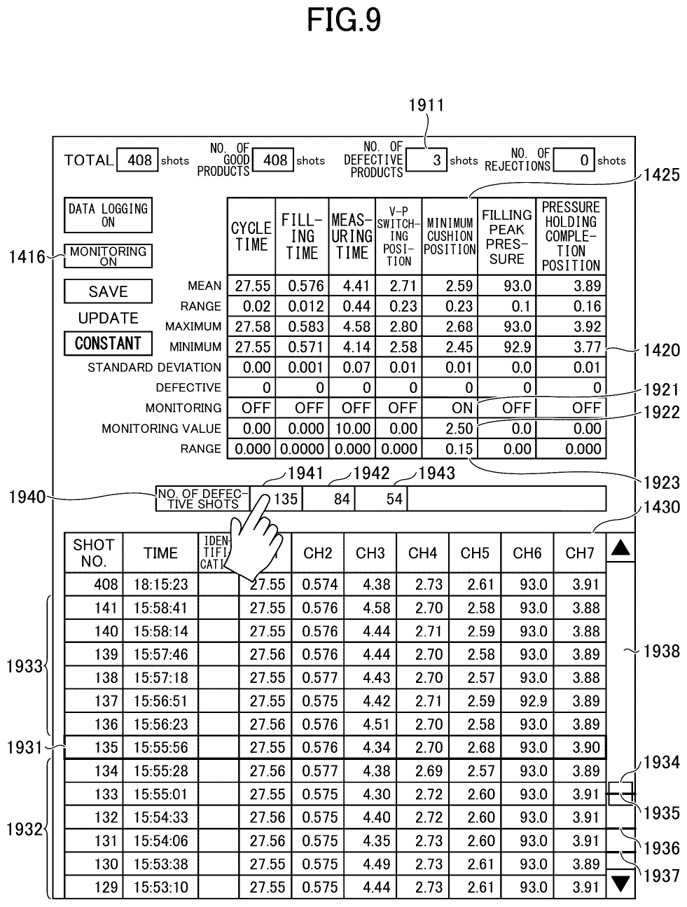

FIG. 9 is a diagram illustrating an example of a log information screen output by the display control unit 712 according to the present embodiment. The log information screen illustrated in FIG. 9 illustrates a defective shot list 1940 in addition to the statistics list 1420 and the result list 1430.

In the example illustrated in FIG. 9, since the monitoring setting button 1416 is pressed (“monitoring ON” is displayed), whether the wafer is defective is monitored for each shot.

In the example illustrated in FIG. 9, as illustrated in the statistics list 1420, the monitoring 1921 is set to “ON” in the column of the setting field 1425 of “minimum cushion position”.

In this case, the control device 700 determines whether the actual value of the “minimum cushion position” satisfies the criteria indicated by the “monitoring value” and the “range” for each shot. For example, the control device 700 determines whether the actual value is included within “0.15” indicated by the “range” 1923 based on “2.50” indicated by the “monitoring value” 1922.

A molded article that does not satisfy the criteria indicated by the “monitoring value” and the “range” is determined as a defective product, in other words, a product in which an abnormality has occurred. In the present embodiment, an example in which a shot number is indicated as information for identifying a molded article (an example of a product) in which an abnormality has occurred will be described. However, the information for identifying a molded article is not limited to the shot number, and may be, for example, a molding time or the like. In the present embodiment, an example in which whether an abnormality has occurred is determined based on the actual value of the “minimum cushion position” will be described. However, in the present embodiment, the determination method is not limited to the determination method based on the actual value of the “minimum cushion position”, and the determination may be made based on other items. Further, in the present embodiment, the determination for identifying the molded article is not limited to the determination of whether an abnormality has occurred in the product, and the determination may be made under other conditions.

Then, when the control device 700 determines that the criteria are not satisfied, the display control unit 712 displays the number of molded articles determined not to satisfy the criteria in the number of defective products 1911.

Further, when the control device 700 determines that the criteria are not satisfied, the display control unit 712 displays the shot number of the molded article determined not to satisfy the criteria in the defective shot list 1940.

In the example n FIG. 9, as illustrated in the number of defective products 1911, there are three molded articles determined not to satisfy the criteria. The shot numbers “135”, “84”, and “54” indicating the molded articles determined not to satisfy the criteria are illustrated in the defective shot list 1940.

In the example illustrated in FIG. 9, the reception unit 711 can receive selection of the cells 1941, 1942, and 1943 corresponding to the shot numbers “135”, “84”, and “54” indicating the molded articles determined not to satisfy the criteria.

When the reception unit 711 receives selection of the cell 1941 corresponding to the shot number “135”, the display of the result list 1430 is switched.

Specifically, the display control unit 712 performs control to scroll the table in the result list 1430 such that the record of the shot number “135” is located at the center of the result list 1430.

The display control unit 712 displays positions 1935, 1936, and 1937 of the shot numbers indicating the molded articles determined not to satisfy the criteria on the scroll bar 1938 of the result list 1430.

In the example illustrated in FIG. 9, since the knob 1934 is present at a position where the position 1935 is the center, a record 1931 corresponding to the position 1935 is displayed at the center of the result list 1430.

With the record 1931 indicating a molded article determined not to satisfy the criteria as a center, records 1933 for six shots molded before the shot indicated by the record 1931 and records 1932 for six shots molded after the shot indicated by the record 1931 are displayed in the order of shots.

That is, when the operator checks the detection result of the molded article which is determined as a defective product, the operator can also check the detection results of the molded articles for the six shots each before and after the molded article.

This enables the operator to check whether a defective product is formed suddenly or as a result of a change in time.

### Modification of Still Another Embodiment

In the still another embodiment, an example in which the shot numbers of the molded articles determined not to satisfy the criteria are displayed in the defective shot list 1940 has been described. However, the still another embodiment is not limited to the example in which the shot numbers of the molded articles determined not to satisfy the criteria are collectively displayed in the defective shot list 1940. In a modification of the still another embodiment, an example in which the shot numbers of the molded articles determined not to satisfy the criteria are displayed separately for each item will be described.

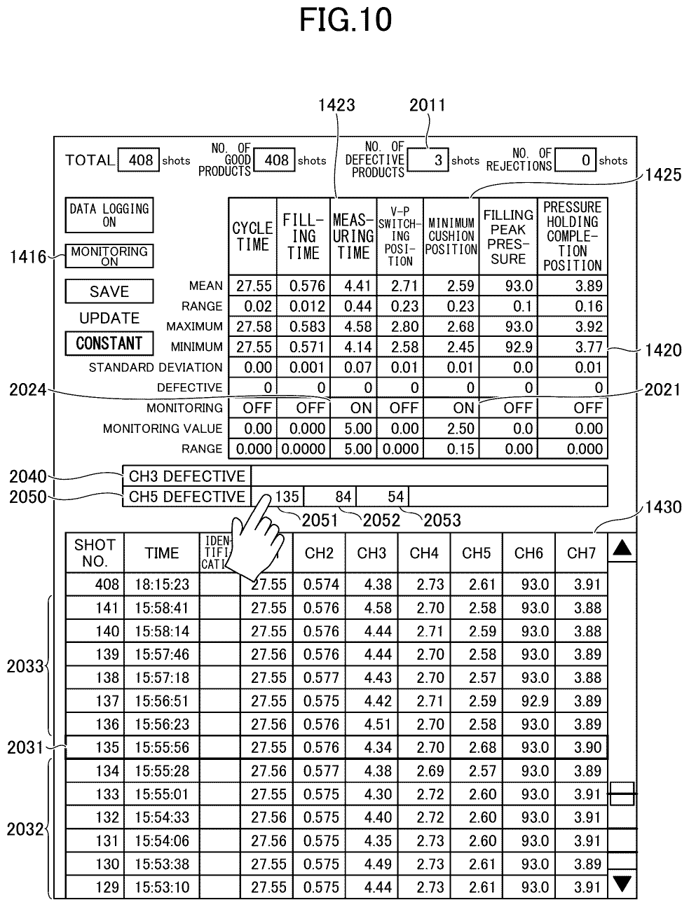

FIG. 10 is a diagram illustrating an example of a log information screen output by the display control unit 712 according to the present modification. The log information screen illustrated in FIG. 10 is different from the log information screen illustrated in FIG. 9 in that a CH3 defective list 2040 and a CH5 defective list 2050 are illustrated instead of the defective shot list 1940.

In the example illustrated in FIG. 10, since the monitoring setting button 1416 is pressed (“monitoring ON” is displayed), whether the wafer is defective is monitored for each shot.

In the example illustrated in FIG. 10, as illustrated in the statistics list 1420, a monitoring 2021 is set to “ON” in the column of the setting field 1423 of “measuring time”, and a monitoring 2024 is set to “ON” in the column of the setting field 1425 of “minimum cushion position”.

In this case, the control device 700 determines whether the actual values of the “measuring time” and the “minimum cushion position” satisfy the criteria indicated by the “monitoring value” and the “range” for each shot. The determination method is the same as in the above-described embodiments, and a description thereof will be omitted.

A molded article that does not satisfy the criteria indicated by the “monitoring value” and the “range” is determined as a defective product, in other words, a product in which an abnormality has occurred.

Then, when the control device 700 determines that the criteria are not satisfied, the display control unit 712 displays the number of molded articles determined not to satisfy the criteria in the number of defective products 1911.

Further, when the control device 700 determines that the “measuring time” does not satisfy the criteria, the display control unit 712 displays the shot number of the molded article determined not to satisfy the criteria in the CH3 defect list 2040. When the control device 700 determines that the “minimum cushion position” does not satisfy the criteria, the display control unit 712 displays the shot number of the molded article determined not to satisfy the criteria in the CH5 defective list 2050.

In the present embodiment, the shot number of the molded article determined to be defective is displayed for each item. That is, in the example illustrated in FIG. 10, since “monitoring” is “ON” in “measuring time” and “minimum cushion position”, the CH3 defective list 2040 and the CH5 defective list 2050 are displayed. In this way, the display control unit 712 may change the defective list to be displayed according to the item in which “monitoring” is “ON”.

The other display areas are the same as those in FIG. 9 of the still another embodiment. That is, when the reception unit 711 receives selection of a cell 2051 corresponding to the shot number “135”, the display control unit 712 displays the records 2033 for six shots molded before the shot indicated by a record 2031 and the records 2032 for six shots molded after the shot indicated by the record 2031 in the order of shots with the record 2031 indicating the molded article determined not to satisfy the criteria as the center.

### Further Another Embodiment

In the above-described embodiments and modifications, the case where the production management device is incorporated in the injection molding machine 10 has been described. However, the above-described embodiment and modifications are not limited to the examples of incorporating the production management device into the injection molding machine 10. That is, a device connected to the injection molding machine 10 via a network may be used as the production management device. In the further another embodiment, a case where a management device connected to the injection molding machine 10 is used as a production management device will be described.

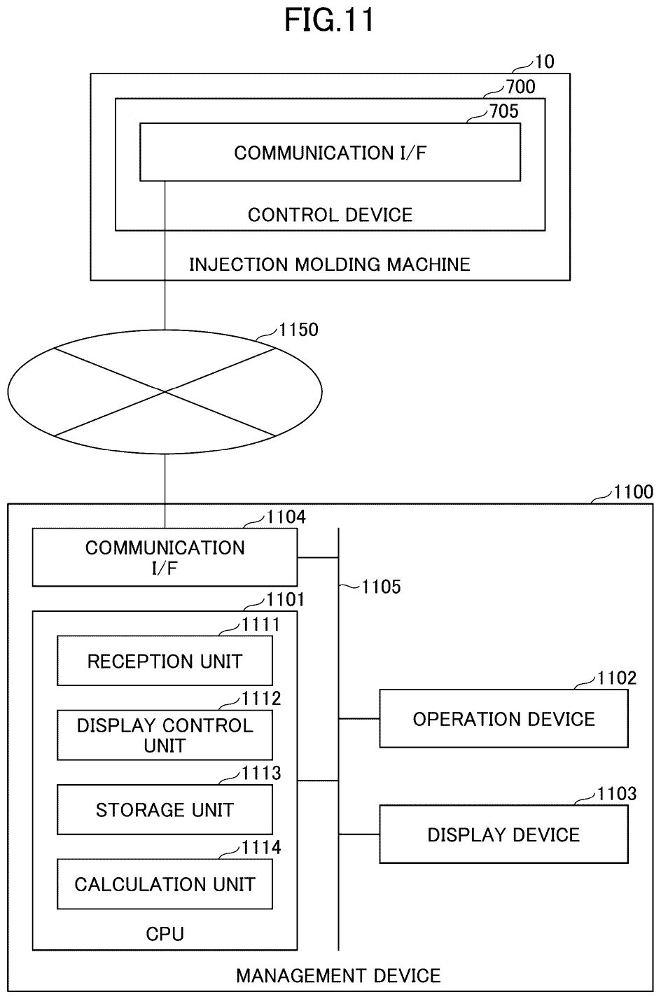

FIG. 11 is a block diagram illustrating a configuration of the injection molding machine 10 and a management device 1100 according to the present embodiment. As illustrated in FIG. 11, the injection molding machine 10 and the management device 1100 are connected via a communication network 1150. The communication network 1150 may be, for example, a network in a factory.

The control device 700 of the injection molding machine 10 transmits log information indicating actual values obtained by the various sensors to the management device 1100 using the communication I/F 705.

The management device 1100 includes a CPU 1101, an operation device 1102, a display device 1103, a communication interface (I/F) 1104, and a bus 1105 that connects these components.

The management device 1100 receives the log information indicating the actual values obtained by various sensors from the control device 700 via the communication I/F 1104.

The CPU 1101 executes a program to implement a reception unit 1111, a display control unit 1112, a storage unit 1113, and a calculation unit 1114. The processes performed by the reception unit 1111, the display control unit 1112, the storage unit 1113, and the calculation unit 1114 are the same as those performed by the reception unit 711, the display control unit 712, the storage unit 713, and the calculation unit 714 in the above-described embodiments and modifications.

That is, the management device 1100 according to the present embodiment includes a reception unit 1111, a display control unit 1112, a storage unit 1113, and a calculation unit 1114, and can thus display a log information screen described in the above-described embodiments and modifications. The displayed log information screen and the operation on the log information screen are the same as those in the above-described embodiments and modifications, and thus the description thereof will be omitted.

### <Operation>

In the above-described embodiments and modifications, the record indicating the detection result of the first molded article is displayed based on the selection received from the operator, and the record indicating the detection result of the molded article molded by the injection molding machine 10 at least immediately before the first molded article and the record indicating the detection result of the molded article molded by the injection molding machine 10 at least immediately after the first molded article are displayed. For example, the operator can identify whether the abnormality of the molded article has suddenly occurred. Since the operator can appropriately identify a change in the situation, the operator can easily analyze the cause of the abnormality.

In the above-described embodiment, the case where a management target in the production management device is the injection molding machine has been described. However, the production device serving as the management target is not limited to the injection molding machine in the above-described embodiments, and an extrusion molding machine, a blow molding machine, or the like may, for example, be applied to the management target. Further, the production device according to the present disclosure is not limited to the device for molding a product by processing plastic or the like, and may be a device for producing a product by processing metal or the like. That is, any production devices capable of mass-producing products using any material such as plastic or metal may be used for the control described in the above embodiments.

Although the embodiments of the production management device according to the present disclosure have been described above, the present disclosure is not limited to the above-described embodiments. Various changes, modifications, substitutions, additions, deletions, and combinations are possible within the scope of the claims. Such modifications are also included in the technical scope of the present disclosure.

What is claimed is:

1. A production management device comprising:
circuitry configured to
display, on a display unit, detection results detected by a detection unit in a process of producing a product upon a plurality of products being produced by a production device; and
display, upon receiving selection of a detection result or information for identifying the product, a detection result of a first product together with a detection result of a second product and a detection result of a third product on the display unit, the first product being identified by the detection result or the information for identifying the product, the second product being produced by the production device immediately before the first product, and the third product being produced by the production device immediately after the first product.

2. The production management device according to claim 1, wherein the circuitry is further configured to
display a detection result extracted from the detection results of each of the plurality of products by a statistical procedure, or the information for identifying the product, the product satisfying a predetermined condition from among the plurality of products produced by the production device, and
display, upon receiving selection of the detection result extracted by the statistical procedure or the information, the detection result of the first product, the detection result of the second product, and the detection result of the third product on the display unit.

3. The production management device according to claim 2, wherein the detection result extracted by the statistical procedure is a maximum value or a minimum value.

4. The production management device according to claim 2, wherein the predetermined condition indicates criteria for determining whether an abnormality has occurred in each of the products.

5. The production management device according to claim 1, wherein the circuitry is further configured to sort, upon receiving selection of a predetermined item, the products based on the detection results classified into the predetermined item to display the sorted products, and receive selection of each of the detection results displayed in a sorted manner.

6. The production management device according to claim 1, wherein the circuitry is configured to filter, upon receiving selection of a predetermined item into which the detection results are classified, the detection results classified into the predetermined item by a predetermined condition, display a filtered detection result, and receive selection of the displayed filtered detection result.

7. The production management device according to claim 1, wherein the circuitry is further configured to perform, upon displaying the detection results of each product in a first display area of the display unit and subsequently receiving selection of the detection result or the information, jumping control or scrolling control to display the detection result of the first product, the detection result of the second product, and the detection result of the third product in the first display area.

8. The production management device according to claim 1, wherein the circuitry is further configured to display a display area different from a display area displaying the detection results detected by the detection unit in a process of producing the products, and display the detection result of the first product, the detection result of the second product, and the detection result of the third product in the display area different from the display area displaying the detection results upon selection of the detection result or the information for identifying the product.

9. The production management device according to claim 1, wherein upon the plurality of products being produced over time by injection molding using an injection molding machine, s the detection results by the detection unit for each product.

10. A production device for producing a plurality of products, the production device comprising:
a display unit configured to display detection results detected by a detection unit in a process of producing a product upon the plurality of products being produced by the production device; and
circuitry configured to display, upon receiving selection of a detection result or information for identifying the product, a detection result of a first product together with a detection result of a second product and a detection result of a third product on a display unit, the first product being identified by the detection result or the information for identifying the product, the second product being produced by the production device immediately before the first product, and the third product being produced by the production device immediately after the first product.
